(19) United States
(12) Patent Application Publication
(10) Pub. No.: US 2002/0140209 A1
(43) Pub. Date: Oct. 3, 2002

(54) Air bag assembly including bias element

(76) Inventors: Bryan T. Waid, Kettering, OH (US); Craig M. Hanson, Kettering, OH (US); Allen Richard Starner, Springboro, OH (US); James Lloyd Webber, Shelby Township, MI (US)

Correspondence Address: KATHRYN A. MARRA, DELPHI TECHNOLOGIES, INC., Legal Staff, Mail Code: 480-414-420, P.O. Box 5052, Troy, MI, 48007-5052, US

(21) Appl. No.: 09/823,264

(22) Filed: Mar. 30, 2001

(51) Int. Cl. B60R 21/16

(52) U.S. Cl. 280/728.2; 280/736

(57) ABSTRACT

An air bag system in a vehicle having opposing upper front interior corners. The system includes at least one air bag assembly located proximate one of the upper front interior corners. The air bag is in fluid communication with a gas expelling inflator and includes a frontal impact portion sized and shaped for deploying along a predetermined deployment path in front of a vehicle occupant. A biasing element of flat pliable character is held in place in hinging relation along an attached edge at an anchoring position inboard of the air bag. The biasing element is unattached at a free end which is extended away from the anchoring position upon deployment of the air bag cushion such that the biasing element is advanced in hinging fashion ahead of the frontal impact portion as the frontal impact portion is deployed in front of the vehicle occupant.

### TECHNICAL FIELD

This invention relates to a vehicle air bag assembly, and more particularly to an air bag assembly including an inflatable cushion deployable from a forward upper corner portion of a vehicle interior in an inflation travel path in front of an occupant to be protected. A biasing element of fabric or other material of flexible character is deployed ahead of the inflatable cushion in leading relation along the path of deployment so as to establish an initial buffer or bridge of material between the inflatable cushion and the occupant or structural elements which may be encountered along the deployment path.

### BACKGROUND OF THE INVENTION

It is well known in motor vehicles to provide an air bag assembly for protecting a vehicle occupant. It is also known to provide an air bag assembly including an air bag and an inflator for generating gas to inflate the air bag upon sensing predetermined vehicle conditions. It is also known to provide an air bag assembly for both front and side impact protection of the vehicle occupant.

Air bags are typically provided in the vehicle steering wheel for the protection of the driver and in the vehicle instrument panel for protection of the vehicle passenger. The air bag assemblies have much different designs for the driver's side and the passenger's side such that two assemblies are separately designed for the vehicle. In addition, the vehicle may also include separate side air bags for use on opposite sides of the vehicle.

It has recently been proposed to utilize air bag cushions deployable from a position adjacent the forward corner of the vehicle interior so as to provide forward protection as well as side protection if desired. One such assembly is illustrated and described in U.S. Pat. No. 6,073,960 to Viano et al. the contents of which are incorporated herein by reference.

### SUMMARY OF THE INVENTION

This invention offer advantages and alternatives over the prior art by providing an air bag assembly which includes a cushion portion to absorb frontal impact which is deployable from a position along an A-pillar of a vehicle generally at the forward corner portion of the vehicle interior and which further includes an efficient and compact biasing element of highly flexible character which travels ahead of the inflatable air bag cushion during deployment so as to promote travel of the air bag along the desired deployment path between the vehicle occupant and opposing portions of the vehicle interior during early stages of deployment. The biasing element provides a supporting bridge of material and assists in the insertion of the cushion between the occupant and the opposing portions of the vehicle interior such that the occupant may be moved into an appropriate position as the air bag cushion is deployed. In the event that the air bag cushion encounters an obstruction within the natural path of deployment, the biasing element provides a deflection surface to aid in moving the inflating air bag cushion around the obstruction and into a desirable operating position. The biasing element is of a sufficiently flexible and compact configuration that it may be stored within the same storage area as the air bag cushion at the A-pillar of the vehicle.

These advantages are accomplished in a potentially preferred form of the present invention by providing an air bag assembly in a vehicle having an upper front interior comer and at least one seating position for a vehicle occupant. The air bag assembly includes an inflator for generating gas; an air bag cushion in fluid communication with the inflator such that the air bag cushion is deployable upon generation of gas by the inflator; and a substantially sheet-like biasing element deployable ahead of the air bag cushion upon deployment of the air bag cushion. The air bag cushion and biasing element are stored proximate the upper front comer of the vehicle and preferably along an A-pillar extending away from the upper front corner. The air bag cushion may have a front portion and a side portion. Upon deployment of the air bag cushion, at least a portion of the air bag cushion deploys downwardly and in front of the vehicle occupant. The biasing element is pushed inboard (i.e. towards the vehicle center) in front of the air bag cushion during deployment to form a buffer between the air bag cushion and structures disposed within the preferred path of deployment. The biasing element is preferably a sheet of textile material secured along one edge to the A-pillar of the vehicle at a position inboard of the folded air bag cushion prior to deployment. The free end of the biasing element may be tucked in stored relation at the outboard side of the folded air bag cushion such that upon deployment of the air bag cushion, the free end of the biasing element is forced outwardly away from the A-pillar and to move in a hinging whip-like fashion ahead of the air bag cushion until coming to rest generally behind the inflated air bag cushion once deployment is completed.

### BRIEF DESCRIPTION OF THE DRAWINGS

The accompanying drawings which are incorporated in and which constitute a part of this specification illustrate a potentially preferred embodiment of the present invention and, together with the general description of the invention provided above and the detailed description set forth below, serve to explain the principles of the invention wherein:

FIG. 1 is a side view of a vehicle interior partially broken away and including a forward corner mounted air bag assembly in an undeployed state;

FIG. 2 is view similar to FIG. 1 but showing the air bag assembly in the deployed condition revealing the inflated air bag cushion;

FIG. 3 illustrates a representative storage arrangement for an air bag cushion and cooperating biasing element on the driver side of a vehicle;

FIG. 4 is a top view of the vehicle illustrating an intermediate stage of deployment of an air bag and associated biasing element according to the present invention on both the driver and passenger sides of the vehicle; and

FIG. 5 is a top view similiar to FIG. 4, illustrating the air bags and associated biasing elements in a substantially fully deployed state.

While the invention has been illustrated and generally described above and will hereinafter be described in connection with certain potentially preferred embodiments, practices and procedures, it is to be understood that in no event is the invention to be limited to such embodiments, practices and procedures. On the contrary, it is intended that the present invention shall extend to any alternative or modification as may embrace the broad principles of this invention within the true spirit and scope thereof.

### DESCRIPTION OF THE PREFERRED EMBODIMENT

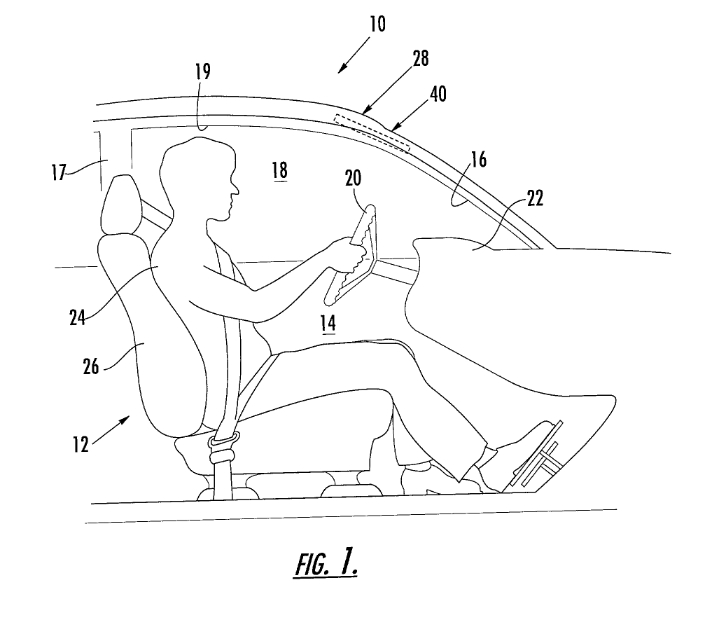

Referring to FIG. 1, it is seen that a vehicle 10 includes a vehicle interior 12 having front doors 14 positioned between front side door pillars 16 (commonly referred to as A-pillars) and rear side door pillars 17 (commonly referred to a B-pillars). Moveable windows 18 are mounted on the doors 14. The vehicle 10 further includes side roof rails 19 extending generally between the A-pillars 16 and the B-pillars 17. Generally located at the intersection of the side roof rails 19 and the A-pillars 16, the vehicle 10 includes opposite front upper interior corners 28. It will be appreciated that the term upper interior corners 28 applies to any location in the area around the intersection of the A-pillars 16 and the roof rails 19 including locations along the A-pillars 16 below the roof rails 19.

As shown, the vehicle 10 also preferably includes a steering wheel 20 and an instrument panel 22 disposed generally in front of at least one vehicle occupant 24 supported by a vehicle seat 26. As will be appreciated, while the view provided is of the driver's side of the vehicle 10, the elements of the vehicle (with the exception of the steering wheel 20) are generally reproduced in a mirror-image fashion on the passenger side of the vehicle 10.

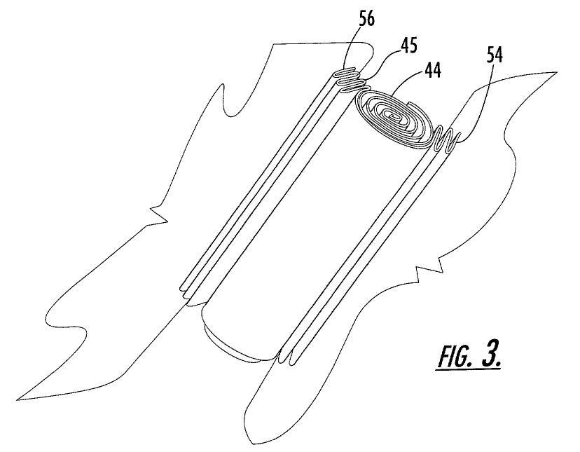

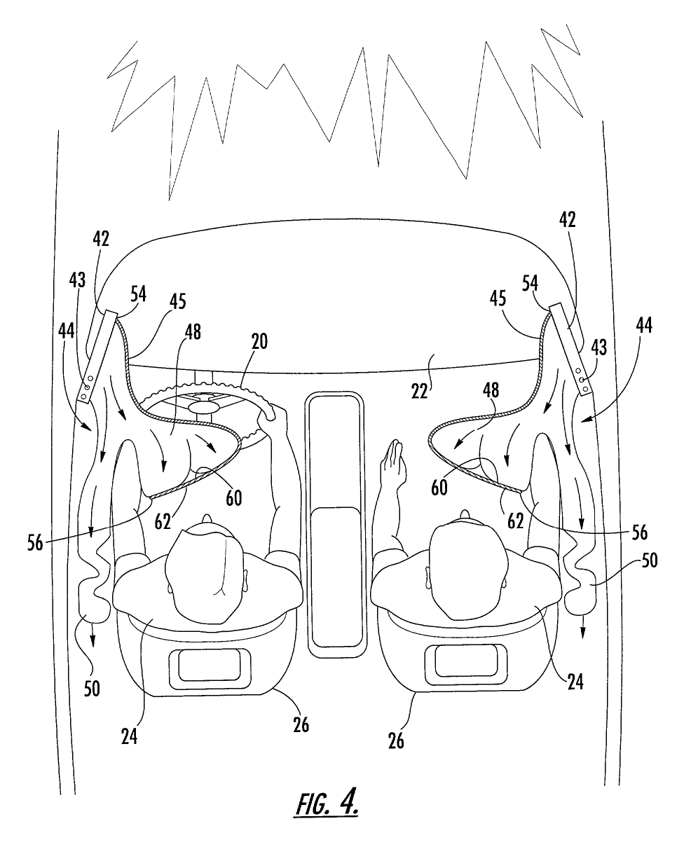

Referring to FIGS. 1-5, air bag assemblies 40 according to the present invention are preferably mounted to the vehicle 10 proximate the upper front interior corners 28. In this regard it is contemplated that the mounting position may be directly at the front upper interior corners 28 formed at the intersections of the A-pillars 16 to the roof rails 19 on either side of the vehicle 10 or along the A-pillars 16 at a position below the roof rails 19 as dictated by the vehicle 10 geometry. The air bag assemblies 40 each preferably include an inflator 42, an air bag 44 and a pliable sheet-like biasing element 45 (FIGS. 3-5). The inflators 42 may preferably be directly attached to the air bags 44 such as by wrapping the air bag 44 around the mounted inflator 42.

Prior to deployment, the inflators 42 and air bags 44 as well as the associated biasing element 45 are preferably hidden from view beneath a plastic interior trim piece covering the A-pillar 16 and the roof rail 19. However, it will be appreciated that the components of the air bag assembly 40 may likewise be contained within a separate frangible housing element of material such as cloth, plastic, or the like that is either mounted atop or beneath the vehicle trim. It will further be appreciated that the air bag assembly 40 could also be stored completely or partially beneath headlining material located in the roof of the vehicle 10 or anywhere generally within the front upper interior corners 28 or along the A-pillars 16. It is likewise to be appreciated that the inflators 42 need not be mounted at the same location as the air bags 44 and biasing element 45 but rather may be located at isolated locations such as within the instrument panel 22. In such a configuration fluid communication may be established and maintained between the inflators 42 and the air bags 44 by means of a suitable gas piping structure formed of material such as fabric, plastic or the like. Such an assembly is believed to be illustrated and described in U.S. patent application Ser. No. 09/545,880 bearing a filing date of Apr. 7, 2000 the contents of which are incorporated herein by reference.

The inflators 42 may be of any conventional construction for the discharge of gas upon the sensing of certain predetermined vehicle conditions. The inflators 42 preferably include a plurality of ports 43 through which the inflator gas is discharged to inflate the air bags 44. By way of example only, and not limitation, one inflator type and mounting arrangement as may be utilized is illustrated and described in U.S. Pat. No. 5,803,486 to Spencer et al. the contents of which are incorporated herein by reference.

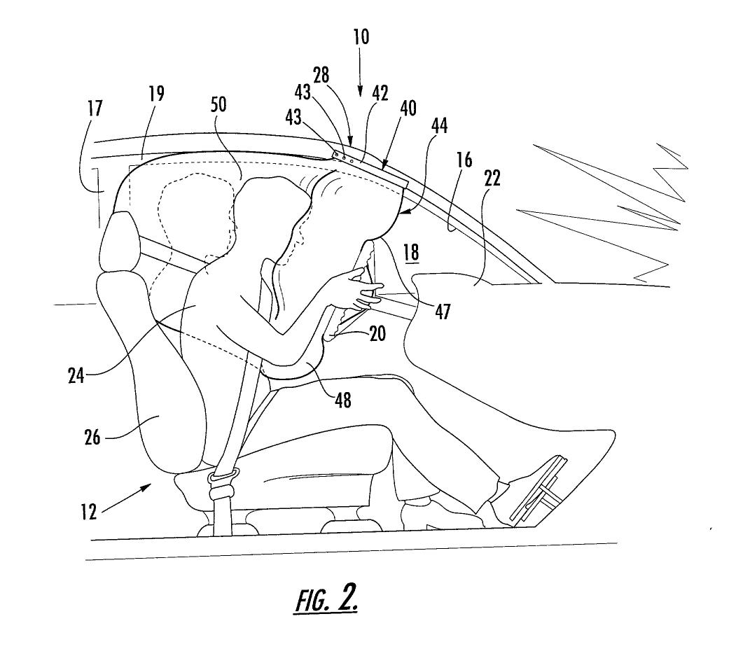

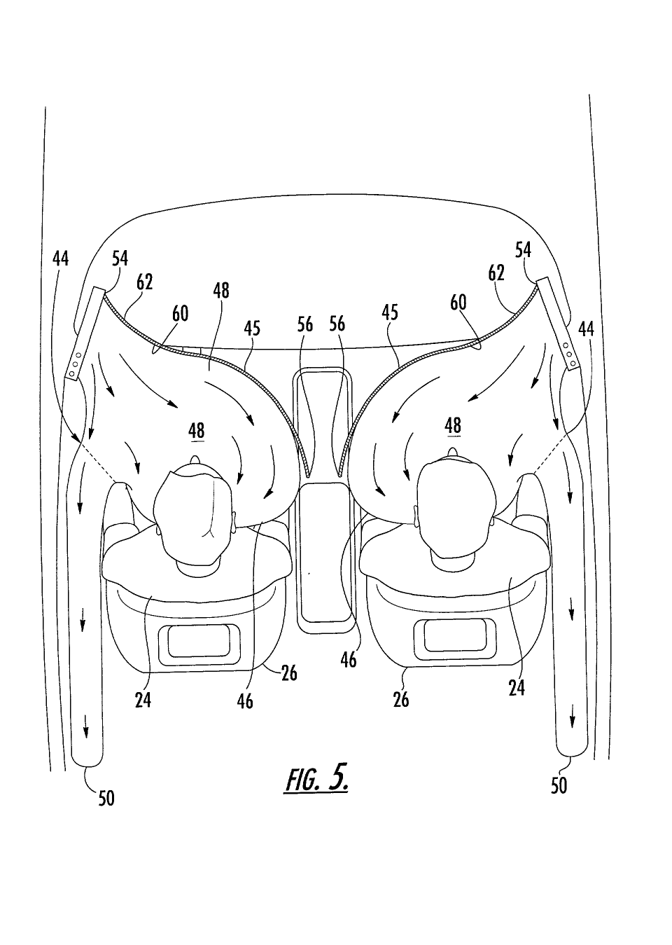

As best seen through simultaneous reference to FIGS. 2, 4 and 5, the air bags 44 are preferably made of a fabric material such as coated or uncoated rip-stop nylon or polyester suitable for rapid inflation. The air bags 44 each include an inboard contact face 46 (FIG. 5) located adjacent the vehicle occupants 24 following deployment, and an outboard contact face 47 (FIG. 2) facing generally away from the vehicle occupants 24 following deployment. According to the illustrated embodiment, each of the air bags 44 includes a frontal impact portion 48 for deployed alignment in front of the vehicle occupants 24. As illustrated, the air bags 44 may also include side portions 50 adapted for alignment with the upper side of the vehicle occupants 24 generally at the location between the doors 14 and the windows 18 of the vehicle 10 and the head and upper torso portions of the occupants 24. However, it is also contemplated that the side portions 50 may be eliminated if desired such that the air bags 44 include only the frontal impact portion 48.

It will be appreciated that advantageously, the air bag assemblies 40 located on the driver and passenger sides of the vehicle 10 are preferably substantially mirror images of each other and can use the same or very similar components and design. Thus, common parts and testing can be used for both the driver and passenger air bag assemblies 40. Also advantageously, common body designs can be used for the front upper interior comers 28 at the A-pillar 16 and roof rail 19 on opposite sides of the vehicle 10 to eliminate the need for different manufacturing operations of these large body components. However, it will likewise be appreciated that there may exist some variations, such as to the shape of the air bag 44 and location of attachment along the A-pillar 16 to account for variations in vehicle geometry from driver to passenger side. Another advantage is that since the air bag assemblies 40 are stored in the A-pillar 16 and roof rail 19 areas, extensive styling freedom is enabled for the steering wheel 20 and the instrument panel 22. In addition, the vehicle interior 12 may be able to provide more occupant space, especially on the passenger side of the vehicle 10.

As best illustrated through simultaneous reference to FIGS. 3-5, according to the present invention the air bag 44 is preferably stored in a substantially rolled or folded condition in underlying relation to a sheet-like biasing element 45. As illustrated, portions of the biasing element 45 may be stored in a tucked relation on either side of the folded air bag 44. The biasing element 45 is attached to the vehicle 10 along an attached edge 54 at an inboard location while the remainder of the biasing element including an opposing free edge 56 is freely deployable away from the position of storage upon deployment of the underlying air bag 44. By way of example only and not limitation, according to one embodiment the biasing element is formed of a single piece of substantially flat fabric of substantially rectangular configuration having a length dimension of about 27 inches and a height dimension of about 20 inches. The side forming the attached edge 54 of the biasing element preferably corresponds to one of the shorter sides and is preferably doubled over and seamed together to provide enhanced strength for attachment to the vehicle 10 at an inboard position along the A-pillar 16.

Upon the vehicle 10 experiencing certain predetermined conditions, a vehicle sensor (not shown) detects conditions for air bag deployment. Various types of sensors may be used, such as Omni-directional or tri-axial sensors which reference algorithms to determine where and when to direct the inflation gas from the inflator 42. As the inflator 42 expels inflation gas into the air bag 44, the air bag 44 is deployed outwardly away from its position of storage. Upon the occurrence of such deployment, the biasing element 45 is likewise forced away from its folded storage position atop the air bag 44.

Due to the fact that the free edge 56 is substantially unrestrained, the biasing element 45 moves ahead of the expanding air bag 44 in a generally leading manner along a predefined deployment path towards the center of the vehicle 10 so as to provide a buffering barrier between the air bag 44 and elements which the air bag 44 may encounter along the path of deployment. By way of example only, in the event that the vehicle occupant 24 is seated in exceptionally close proximity to the steering wheel 20 or instrument panel 22, the presence of the biasing element 45 between the vehicle occupant 24 and the air bag 44 during the early stages of deployment provides the air bag 44 with a relatively uniform surface of substantial area with which to interact while achieving the desired position of final deployment. The biasing element 45 thus acts as a relatively uniform bridging support for the occupant 24 and a deflection surface to aid in the proper positioning of the air bag 44.

As previously indicated, the biasing element 45 is preferably of a substantially flat configuration. The biasing element 45 thus will preferably include an air bag contact surface 60 for interaction with the air bag 44 and an external element contact surface 62 for contacting elements along the path of deployment. It is contemplated that the biasing element 45 is most preferably formed of a woven, knitted or non-woven textile material of similar nature to the material forming the air bag 44. A textile structure of woven construction formed from multi-filament yarns having a yarn linear density of about 210 denier to about 840 denier and a filament linear density of not greater than about 6 denier per filament may be preferred. Woven textile structures formed from multi-filament yarns with a linear density of about 630 denier per yam and a filament linear density of about 3 to 6 denier per filament may be particularly preferred. Nylon textile fabrics may be particularly preferred but it is likewise contemplated that any number of other materials and constructions may also be used including woven, knitted or non-woven structures formed from other materials such as polyester or other fibers as well as non-textile structures.

According to one potential embodiment of the present invention, the biasing element is formed of fabric with no coating or other surface treatment. However, it is also contemplated that in some instances that the air bag contact surface 60 and/or the external element contact surface 62 may be provided with some type of surface treatment if desired.

According to one potential embodiment of the present invention, it is contemplated that the air bag contact surface 60 of the biasing element 45 may be treated in such a manner as to reduce the coefficient of friction between the air bag contact surface 60 and the air bag 44 during deployment. In order to provide such reduced friction between the air bag 44 and the air bag contact surface 60, it is contemplated that the air bag contact surface 60 may be at least partially coated with a friction reducing composition. By way of example only, such friction reducing materials may include silicone, TEFLON®, or other materials as may be compatible with the surface character of the air bag 44. It is also contemplated that the biasing element may be subject to surface treatment methods such as hot calendering and the like as may be used to provide a smooth, low friction air bag contact surface 60 in an uncoated state if desired.

According to another potential embodiment, it is contemplated that the external element contact surface 62 may be of a relatively high friction character so as to further enhance the ability of the external element contact surface 62 to substantially conform to the contour of an out of position occupant or other obstruction as may be encountered as the air bag 44 slides over the air bag contact surface 62. In the event that the biasing element 45 is to be provided with an external element contact surface 62 exhibiting increased friction, it is contemplated that the desired frictional character of the external element contact surface 62 may be attained by applying a coating of a tacky material such as neoprene rubber or the like across at least a portion of the external element contact surface 62 to increase the friction thereof It is further contemplated that such friction enhancing coatings across the external element contact surface 62 may be used in conjunction with friction reducing surface treatments across the air bag contact surface 60 so as to provide cumulative beneficial results.

As will be appreciated, the utilization of the air bag assemblies 40 incorporating the biasing elements 45 provides a practical and cost effective mechanism for promoting the efficiency of the air bags 44 in some applications. While the present invention has been illustrated and described in relation to certain potentially preferred embodiments, constructions and procedures, it is to be understood that such embodiments, constructions and procedures are illustrative only and that the present invention is in no event to be limited thereto. Rather, it is contemplated that modifications and variations embodying the principles of the present invention will no doubt occur to those of skill in the art to which this invention pertains. It is therefore contemplated and intended that the present invention shall extend to all such modifications and variations as may incorporate the broader aspects of the present invention within the full spirit and scope of the claims appended hereto and all equivalents.

1. An air bag system in a vehicle having opposing upper front interior corners, the vehicle having a driver side and a passenger side including seats for supporting vehicle occupants on opposing sides of the vehicle adjacent the upper front interior corners, the air bag system comprising:
at least a first air bag assembly located proximate one of the upper front interior comers comprising an air bag in fluid communication with a gas expelling inflator, wherein the air bag includes at least a frontal impact portion being sized and shaped for deploying along a predetermined deployment path in front of a vehicle occupant; and a biasing element of substantially flat pliable character which is held in place in substantially hinging relation along an attached edge at an anchoring position adjacent the air bag, the biasing element being extended away from the anchoring position upon deployment of the air bag such that the biasing element is advanced in hinging fashion ahead of the frontal impact portion of the air bag along the deployment path as the frontal impact portion is deployed in front of the vehicle occupant.

2. The invention according to claim 1, wherein said first air bag assembly is located at the upper front interior corner at the driver side of the vehicle.

3. The invention according to claim 1, wherein said first air bag assembly is located at the upper front interior comer at the passenger side of the vehicle.

4. The invention according to claim 1, wherein said first air bag assembly is located along a n A-pillar at the passenger side of the vehicle.

5. The invention according to claim 1, wherein said first air bag assembly is located along an A-pillar at the driver side of the vehicle.

6. The invention according to claim 1, wherein the biasing element comprises a sheet of textile material.

7. The invention according to claim 6, wherein the biasing element comprises a textile material of woven construction formed from a plurality of filament yams.

8. The invention according to claim 7, wherein said filament yarns are characterized by a linear density in the range of about 210 to about 840 denier.

9. The invention according to claim 8, wherein said filament yarns are characterized by a filament linear density of not greater than about 6 denier per filament.

10. The invention according to claim 8, wherein said filament yams are nylon yarns.

11. The invention according to claim 8, wherein said filament yarns are polyester yarns.

12. The invention according to claim 1, wherein a friction reducing surface finish extends across at least a portion of a face of the biasing element in facing relation to the air bag during deployment.

13. The invention according to claim 1, wherein a friction enhancing surface finish extends across at least a portion of a face of the biasing element facing away from the air bag during deployment.

14. The invention according to claim 1, wherein a lubricating coating extends across at least a portion of a face of the biasing element in facing relation to the air bag during deployment and wherein a friction enhancing coating extends across at least a portion of a face of the biasing element facing away from the air bag during deployment.

15. The invention according to claim 1, wherein the air bag further includes a side impact portion in fluid communication with the frontal impact portion, and wherein the side impact portion is sized and shaped for deploying downwardly and to the side of the vehicle occupant.

16. An air bag system in a vehicle having opposing upper front interior comers, the vehicle having a driver side and a passenger side including seats for supporting vehicle occupants on opposing sides of the vehicle adjacent the upper front interior corners, the air bag system comprising:
a first air bag assembly located proximate one of the upper front interior comers and a second air bag assembly proximate the other of the upper front interior corners, each of said first and second air bag assemblies comprising an air bag in fluid communication with a gas expelling inflator, wherein the air bag includes at least a frontal impact portion being sized and shaped for deploying downwardly along a predetermined inboard deployment path in front of a vehicle occupant, each of the first and second air bag assemblies further comprising a biasing element of substantially flat pliable character which is held in place in substantially hinging relation along an attached edge at an anchoring position adjacent the air bag, the biasing element being extended away from the anchoring position upon deployment of the air bag such that the biasing element is advanced in hinging fashion ahead of the frontal impact portion of the air bag along the deployment path towards the center of the vehicle as the frontal impact portion is deployed in front of the vehicle occupant.

17. The invention according to claim 16, wherein the biasing element comprises a sheet of textile material.

18. The invention according to claim 17, wherein the biasing element comprises a textile material of woven construction formed from a plurality of filament yarns.

19. The invention according to claim 18, wherein said filament yarns are characterized by a linear density in the range of about 210 to about 840 denier.

20. The invention according to claim 19, wherein said filament yarns are characterized by a filament linear density of about 3 to about 6 denier per filament.

21. The invention according to claim 16, wherein the biasing element comprises a sheet of textile material and wherein the air bag further includes a side impact portion in fluid communication with the frontal impact portion, the side impact portion being sized and shaped for deploying downwardly and to the side of the vehicle occupant.

22. The invention according to claim 16, wherein a friction reducing surface finish extends across at least a portion of a face of the biasing element in facing relation to the air bag during deployment.

23. The invention according to claim 16, wherein a friction enhancing surface finish extends across at least a portion of a face of the biasing element facing away from the air bag during deployment.

24. The invention according to claim 16, wherein a lubricating coating extends across at least a portion of a face of the biasing element in facing relation to the air bag during deployment and wherein a friction enhancing coating extends across at least a portion of a face of the biasing element facing away from the air bag during deployment.

25. An air bag system in a vehicle having opposing upper front interior corners, the vehicle having a driver side and a passenger side including seats for supporting vehicle occupants on opposing sides of the vehicle adjacent the upper front interior corners and first and second forward pillar elements extending generally in front of and to the side of said seats on opposing sides of the vehicle, the air bag system comprising:
a first air bag assembly located proximate one of the upper front interior comers and a second air bag assembly proximate the other of the upper front interior corners, each of the first and second air bag assemblies comprising an air bag stored at a position extending at least partially along one of said first and second forward pillar elements wherein the air bag is in fluid communication with a gas expelling inflator and wherein the air bag includes at least a frontal impact portion being sized and shaped for deploying downwardly along a predetermined inboard deployment path in front of a vehicle occupant; each of said first and second air bag assemblies further including a biasing element of substantially flat pliable character which is held in place in substantially hinging relation along an attached edge at an anchoring position generally inboard of the air bag, the biasing element including an unattached free edge substantially opposing the attached edge, the free edge being extended away from the anchoring position upon deployment of the air bag such that the biasing element is advanced in hinging fashion ahead of the frontal impact portion of the air bag along the inboard deployment path as the frontal impact portion is deployed in front of the vehicle occupant.
